(19) United States
(12) Patent Application Publication
(10) Pub. No.: US 2024/0383223 A1
(43) Pub. Date: Nov. 21, 2024

(54) Sandwich composite board

(71) Applicant: Xuancheng Fengrun New Material Co., Ltd., Xuancheng (CN)

(72) Inventor: Xiaofan Zhang, Xuancheng (CN)

(21) Appl. No.: 18/318,114

(22) Filed: May 16, 2023

(51) Int. Cl. B32B 3/12; B32B 5/02; B32B 7/12; B32B 9/04; B32B 15/08

(52) U.S. Cl. CPC B32B 3/12; B32B 5/022; B32B 7/12; B32B 9/042; B32B 9/045; B32B 15/08; B32B 2250/05; B32B 2250/40; B32B 2262/101; B32B 2262/144

(57) ABSTRACT

The present invention discloses a sandwich composite board including a core layer, two intermediate layers and two outer layers, the core layer is provided with an outer layer on each side, an intermediate layer is provided between the outer layer and the core layer, one side of the intermediate layer is bonded to the core layer and the other side of the intermediate layer is bonded to the outer layer. The present invention enables the composite board to have a better overall performance by bonding the core layer to the outer layer by means of an intermediate layer, each layer is made of a different material.

### TECHNICAL FIELD

This invention is relevant to composite board, especially a sandwich composite board.

### BACKGROUND TECHNOLOGY

Composite boards are made up of two or more materials with different features, which, through physical or chemical methods, form a material with new properties on a macro level. A variety of materials in the performance of each other's strengths and weaknesses, resulting in a synergistic effect, so that the composite plate comprehensive performance better than the original composition of materials to meet a variety of different requirements, and is now widely used.

Most of the existing composite boards are directly bonded to each other, however, there are several drawbacks to this connection:

The smooth surface of the plate and the sheet has poor adhesion during bonding and tends to peel off after bonding, therefore, it is necessary to propose further solutions to the above problems.

### About the Invention

The purpose of the present invention is to provide a sandwich composite board which, by means of an improvement in the structure of the panel, makes the composite panel more firmly bonded and less likely to fall off.

In order to solve the above problems of the existing technology, the technical solution adopted in the invention is as follows.

A sandwich composite board includes a core layer, two intermediate layers and two outer layers.

Both sides of the core layer are provided with an outer layer, an intermediate layer is provided between the outer layer and the core layer.

As the intermediate layer is rough, the contact area between the core layer and the outer layer increased, which makes the bonding more solid, secondly, the use of different materials for each layer makes the composite board a better overall performance, finally, due to uneven surface of the core layer, especially the honeycomb structure of these materials, the use of the intermediate layer also makes the outer layer surface smooth to achieve aesthetic effects.

Further, the intermediate layer is made of any one or several of non-woven fabric, polyester felt, fibre felt, leather, cotton or plastic fibreboard, the intermediate layer is bonded to the core layer, the intermediate layer mainly through its own rough material properties, allows the core layer to be bonded more firmly to the outer layer by increasing the bonding area. The intermediate layer can therefore be made of a material with a rough surface and good bonding properties. The best bonding effect is achieved by using a non-woven fabric as an intermediate layer. When using a non-woven fabric as an intermediate layer, an adhesive plastic film is preferably used to make the non-woven fabric bond more firmly to the PP honeycomb core layer by means of heat fusion, the use of adhesive materials such as non-woven fabric for the intermediate layer increases the roughness of the surface of the core layer, thus increasing the contact area between the core layer and the outer layer, making the core layer more firmly connected to the outer layer firm. The non-woven fabric is made of polyester fiber, terylene fiber, cotton, hemp, glass fiber, rayon, synthetic fiber, which has the characteristics of light weight and softness, good antibacterial and alkali corrosion performance.

Further, the intermediate layer is made of an adhesive material, the core layer, the intermediate layer and the outer layer are bonded and fixed to each other by glue, the intermediate layer is made of wood or metal plate, by using wood or metal plate, the bending strength of the composite board is increased. By using the above technical solution, the core layer, intermediate layer and outer layer are fixed to each other by glue bonding, which facilitates production.

Further, the core layer includes a lightweight layer in the form of a honeycomb structure, the lightweight layer is PP honeycomb board or aluminium honeycomb board layer, by using the above technical solutions, PP honeycomb board has the characteristics of light weight, good heat insulation, excellent chemical stability and electrical insulation, and can be widely used in the compartment of the van, on the one hand, it is conducive to reducing the overall weight of the vehicle, on the other hand, it improves the heat insulation and thermal insulation effect of the compartment, aluminium honeycomb board has excellent properties such as high wind pressure resistance, vibration damping, sound insulation, thermal insulation, flame retardant and high specific strength.

Further, the core layer includes an insulation layer, the insulation layer can be any one or several of polyurethane insulation board layer, XPS extruded plastic board layer, PVC foam board layer, PP foam board layer or PET foam board layer, the insulation layer is provided with grooves, the grooves can be opened on one side of the insulation layer or on both sides of the insulation layer, in addition, the insulation layer can have a brushing treatment applied to the surface instead of grooves. The width of the groove ranges from 6 to 8 mm and the depth from 3 to 4 mm, the grooves can be wavy grooves or serrated grooves, by using the above technical solutions, the XPS extruded plastic board has the characteristics of high thermal resistance, low linearity and low expansion ratio, its structure has a closed porosity of over 99%, which forms a vacuum layer to avoid air flow heat dissipation, ensuring its lasting and stable thermal insulation performance, further improving the heat insulation performance of the compartment. In addition, the XPS extruded board has very low water absorption, when the composite board is applied to the compartment, it makes the compartment has good moisture resistance. Plastic and plastic foam boards used in core material have to be grooved or furred in order to facilitate the exhaustion of the boards after the glue has been applied and to increase the roughness for a solid bond without bulging. The grooving and surface brushing can be done on one side or both sides, each side can be grooved or brushed in any combination.

Further, the outer material includes one or several of fiberglass fiberboard, metal plate, plastic fiberboard or flexible plate, fiberglass fiberboard is corrosion resistant, aging resistant, high specific strength and can replace metal panels, resist scratching and a low conduction coefficient to achieve thermal insulation. Plastic fibre board has good elasticity, not easy to crash under high impact, and light weight, plastic fibre board is made up of synthetic resins and additives such as fillers, plasticizers, stabilizers, lubricants, colours, it is chemically resistant, glossy, mostly good insulators, light and strong, easy to process for mass production, cheap, versatile, useful, easy to colour, partially resistant to high temperatures and has a moisture-proof effect for the storage goods.

Further, the fibreglass, metal, plastic and flexible boards can be either flat or designed with a pattern in a concave or convex shape, the pattern height or depth ranging from 0.2 MM to 5 MM, each concave or convex pattern unit can be identical or partially identical or completely inconsistent in shape, with each concave or convex pattern unit is completely independent of each other to achieve a good 3D effect, and the cover colour can be designed as a single variety of colours or as a non-single colorful colour.

Further, the fiberglass board can be any combination of polyester resin layer+polyester fiber matrix layer, polyester resin layer+polyester fiber matrix layer+polyester resin layer or polyester fiber matrix layer.

Further, the plastic fibre board may be any combination of a plastic layer+plastic fibre matrix layer, a plastic layer+plastic fibre matrix layer+plastic layer, or a plastic fibre matrix layer.

The beneficial effects of the invention are as follows.

The core layer are provided with non-woven fabric on both upper and lower ends to increase the roughness of the outer surface of the core layer, thus increasing the contact area between the core layer and the outer layer and making the connection between the core layer and the outer layer firm, the non-woven fabric is made of polyester fiber, terylene fiber, cotton, hemp, glass fiber, rayon, synthetic fiber, the non-woven fabric has the characteristics of lightness and softness, good antibacterial and anti-corrosion properties of alkali.

2. The core layer is provided with grooves or brushing surface, on the one hand, when the outer layer is bonded to the core layer, the air existing between the glue and the insulation layer can be discharged from the grooves or woolen surface to prevent the bulging phenomenon of this composite board, on the other hand, increase the roughness between the core layer and the outer layer to improve the solidity of the connection between the outer layer and the core layer.

### DESCRIPTION OF DRAWINGS

FIG. 1 is the structure schematic diagram of the present invention 1.

FIG. 2 is the structure schematic diagram of the present invention 2.

FIG. 3 is the structure schematic diagram of the intermediate board.

In the figure: 1-Outer layer; 2-Intermediate layer; 3-Core layer; 4-Light weight layer; 5-Insulation layer; 51-Grooves.

### The Concrete Method to Carry Out

The following instruction further explains the invention's concrete implementation method.

In order to enable a clearer understanding of the objects mentioned above, features and advantages of the present invention, the invention is described in detail below in connection with the accompanying drawings and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connection, it can also be a detachable connection or an integral connection. it can be a mechanical connection or an electrical connection. it can be a direct connection or an indirect connection through an intermediate media, and it can be internal connection within two assemblies. For those of ordinary skill in this field, specific meanings of the above terms in the present invention can be understood in specific situations.

The specific embodiments of the present invention will be described in detail below in connection with the accompanying drawings. It should be understood that the specific embodiments described herein are intended only to illustrate and explain the present invention and not to limit it.

### Embodiment 1

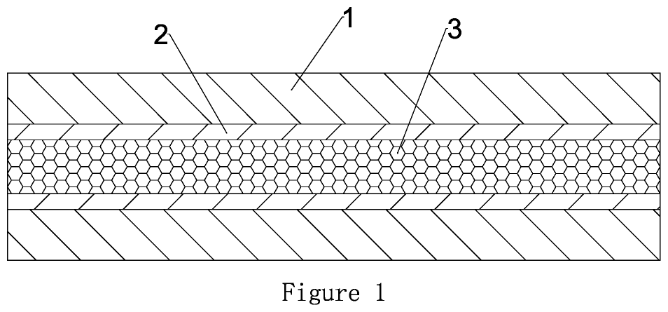

As shown in FIGS. 1, a sandwich composite board including a core layer 3, two intermediate layers 2 and two outer layers 1.

Both sides of the core layer 3 are respectively provided with an outer layer 1, an intermediate layer 2 is provided between the outer layer 1 and the core layer 3.

As the intermediate layer 2 is rough, the contact area between the core layer 3 and the outer layer 1 increased, which makes it more solid after bonding, secondly, each layer is made of different materials, making the comprehensive performance of the composite board better, and finally, due to the uneven surface of the core layer 3, especially the honeycomb structure of these materials, the use of the intermediate layer 2 also make the surface of the outer layer 1 flat to achieve aesthetic effects.

### Embodiment 2

On the basis of embodiment 1, the intermediate layer 2 is made of any one or several of non-woven fabric, polyester felt, fibre felt, leather, cotton or plastic fibreboard, the intermediate layer 2 is bonded to the core layer 3.

The intermediate layer 2, mainly through its own rough material properties, allows the core layer 3 to be bonded more firmly to the outer layer 1 by increasing the bonding area. The intermediate layer 2 can therefore be made of a material with a rough surface and good bonding properties. The best bonding effect is achieved by using a non-woven fabric as intermediate layer 2. When using a non-woven fabric as intermediate layer 2, an adhesive plastic film is preferably used to make the non-woven fabric bond more firmly to the PP honeycomb core layer by means of heat fusion.

The use of adhesive materials such as non-woven fabric for the intermediate layer 2 increases the roughness of the surface of the core layer 3, thus increasing the contact area between the core layer 3 and the outer layer 1, making the core layer 3 more firmly connected to the outer layer 1.

The non-woven fabric is made of polyester fiber, terylene fiber, cotton, hemp, glass fibre, rayon, synthetic fibre, which has the characteristics of lightness and softness, good antibacterial and alkali corrosion performance.

### Embodiment 3

On the basis of embodiment 1, the intermediate layer 2 is made of an adhesive material, the core layer 3, the intermediate layer 2 and the outer layer 1 are fixed and bonded to each other by glue.

The intermediate layer 2 is made of wood or metal plate.

By using wood or metal plates, the bending strength of the composite board is increased.

By using the above technical solution, the core layer 3, the intermediate layer 2 and the outer layer 1 are fixed to each other by glue bonding, which facilitates production.

### Embodiment 4

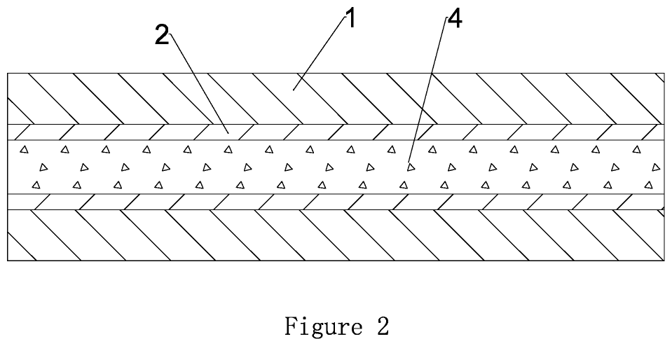

On the basis of embodiment 2 or 3, as shown in FIG. 2, the core layer 3 includes a light weight layer 4 in the form of a honeycomb structure, the light weight layer 4 is a PP honeycomb board or an aluminium honeycomb board layer.

By using the above technical solutions, PP honeycomb board has the characteristics of light weight, good heat insulation, excellent chemical stability and electrical insulation, and can be widely used in the compartment of the van, on the one hand, it is conducive to reducing the overall weight of the compartment, on the other hand, it improves the heat insulation and thermal insulation effect of the compartment; aluminum honeycomb board has excellent properties such as high wind pressure resistance, vibration damping, sound insulation, thermal insulation, flame retardant and high specific strength.

The lightweight layer 4 itself is a honeycomb structure, which can act as an exhaust, so there is no need for brushing or grooving 51.

### Embodiment 5

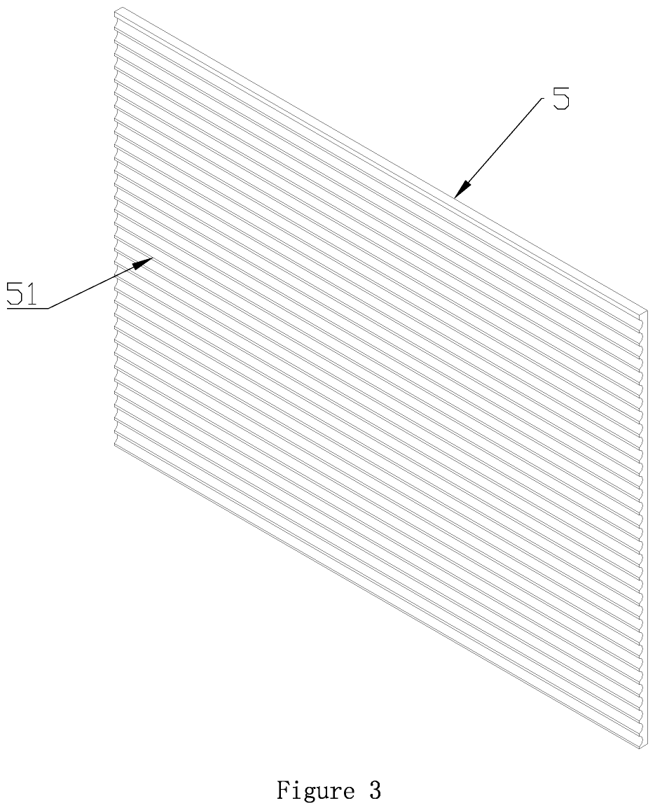

On the basis of embodiment 3 or 4, as shown in FIG. 3, the core layer 3 includes an insulation layer 5, the insulation layer 5 can be any one or several of polyurethane insulation board layer, XPS extruded plastic board layer, PVC foam board layer, PP foam board layer or PET foam board layer, the insulation layer 5 is provided with grooves 51, the grooves 51 can be opened on one side of the insulation layer 5 or on both sides of the insulation layer 5, In addition, the insulation layer 5 can have a brushing treatment applied to the surface instead of the grooves 51.

The width of the groove 51 ranges from 6 to 8 mm and depth from 3 to 4 mm. The groove 51 can be a wavy groove 51 or a serrated groove 51.

By using the above technical solutions, the XPS extruded plastic board has the characteristics of high thermal resistance, low linearity and low expansion ratio, its structure has a closed porosity of over 99%, which forms a vacuum layer to avoid air flow heat dissipation, ensuring its lasting and stable heat insulation performance, further improving the heat insulation of the compartment, and, in long time use, XPS extruded plastic board does not age, does not decompose, does not produce harmful substances, its chemical properties are extremely stable, it can still maintain superior performance in high temperature environments, in addition, the XPS extruded board has very low water absorption, when the composite board is applied to the compartment, it makes the compartment a good moisture resistance.

The insulation layer 5 is any one or several of polyurethane insulation board layer, XPS extruded plastic board layer, PVC foam board layer, PP foam board layer, or PET foam board layer. Plastic and plastic foam boards used in core materials have to be grooved or brushed in order to facilitate the exhaustion of the boards after the glue has been applied and to increase the roughness for a solid bond without bulging. The grooving and surface brushing can be done on one or both sides, and each side can be grooved or brushed in any combination.

### Embodiment 6

On the basis of embodiment 1, the outer layer 1 material includes any one or several of fiberglass fiberboard, metal plate, plastic fiberboard or flexible plate. Fiberglass fiberboard is corrosion resistant, aging resistant, high specific strength and can replace metal panels, resist scratching and a low conduction coefficient to achieve thermal insulation. Plastic fibreboard has good elasticity, not easy to crash under high impact, and light weight.

Metal board is easy processing, well formed, have a high fire resistance limit, and are also available in a wide range of colours, forms and plasticity.

Plastic fibreboard is made up of synthetic resins and fillers, plasticisers, stabilisers, lubricants, colours, etc. It is chemically resistant, glossy, mostly good insulators, light and strong, easy to process for mass production, cheap, versatile, useful, easy to colour, partially resistant to high temperatures and it has a moisture-proof effect for the storage goods.

### Embodiment 7

On the basis of embodiment 6, the fiberglass, metal, plastic and flexible boards can be either flat or designed with a concave or convex pattern, the pattern height or depth ranging from 0.2 MM to 5 MM, each concave or convex pattern unit can be identical or partially identical or completely inconsistent in shape, with each concave or convex pattern unit is completely independent of each other to achieve a good 3D effect, the cover colour can be designed as a single variety of colours or as a non-single colorful colour.

The fiberglass board can be any combination of polyester resin layer+polyester fibre matrix layer, polyester resin layer+polyester fibre matrix layer+polyester resin layer or polyester fibre matrix layer.

### Embodiment 8

On the basis of embodiment 6, the plastic fibre board may be any combination of a plastic layer+plastic fibre matrix layer, a plastic layer+plastic fibre matrix layer+plastic layer or plastic fibre matrix layer.

The invention is not limited to the above-mentioned optional embodiments, anyone can come up with various other forms of products under the inspiration of the invention, however, regardless of any changes in its shape or structure, all technical solutions that fall within the scope defined by the claims of the present invention shall fall within the scope of protection of the invention.

1. A sandwich composite board, wherein, it includes a core layer (3), two intermediate layers (2) and two outer layers (1);
the core layer (3) is provided with an outer layer (1) on each side, an intermediate layer (2) is provided between the outer layer (1) and the core layer (3).

2. A sandwich composite board according to claim 1, wherein, the material of the intermediate layer (2) is any one or several of non-woven fabric, polyester felt, fibre felt, leather, cotton or plastic fibreboard, the intermediate layer (2) is bonded to the core layer (3).

3. A sandwich composite board according to claim 1, wherein, the non-woven fabric is made of polyester fiber, terylene fiber, cotton, hemp, glass fiber, rayon, synthetic fiber.

4. A sandwich composite board according to claim 1, wherein, the intermediate layer (2) is made of an adhesive material, the core layer (3), intermediate layer (2), outer layer (1) are bonded and fixed to each other by glue.

5. A sandwich composite board according to claim 4, wherein, the material of the intermediate layer (2) is a wooden plate, metal plate.

6. A sandwich composite board according to claim 1, wherein, the core layer (3) includes a light weight layer (4) in the form of a honeycomb structure, the light weight layer (4) is a PP honeycomb board or aluminum honeycomb board layer.

7. A sandwich composite board according to claim 1, wherein, the core layer (3) includes an insulation layer (5), the insulation layer (5) is any one or several of polyurethane insulation board layer, XPS extruded plastic board layer, PVC foam board layer, PP foam board layer or PET foam board layer, the insulation layer (5) is provided with grooves (51).

8. A sandwich composite board according to claim 1, wherein, the material of the outer layer (1) includes any one or several of fiberglass boards, metal boards, plastic fiber boards, flexible boards.

9. A sandwich composite board according to claim 1, wherein, the outer layer (1) is engraved with a concave and convex pattern, the pattern depth ranging from 0.2 MM to 5 MM.

10. A sandwich composite board according to claim 1, wherein, the fiberglass board is any one or several of polyester resin layer+polyester fiber matrix layer, polyester resin layer+polyester fiber matrix layer+polyester resin layer or polyester fiber matrix layer.

11. A sandwich composite board according to claim 1, wherein, the plastic fibre board is any one or several of plastic layer+plastic fibre matrix layer, plastic layer+plastic fibre matrix layer+plastic layer or plastic fibre matrix layer.
